(19) United States
(12) Patent Application Publication
(10) Pub. No.: US 2021/0110248 A1
(43) Pub. Date: Apr. 15, 2021

(54) IDENTIFYING AND OPTIMIZING SKILL SCARCITY MACHINE LEARNING ALGORITHMS

(71) Applicant: International Business Machines Corporation, Armonk, NY (US)

(72) Inventors: Karen Midkiff, Sebring, FL (US); Anshul Sheopuri, Oradell, NJ (US); Yvonne Cai Feng Low, Singapore (SG); Thomas A. Stachura, Wheaton, IL (US); Nickle Jaclyn LaMoreaux, Brewster, NY (US); Joanna M. Daly, Dobbs Ferry, NY (US); Ying Li, Mohegan Lake, NY (US)

(21) Appl. No.: 16/599,886

(22) Filed: Oct. 11, 2019

(51) Int. Cl. G06N 3/08; G06N 3/04; G06Q 10/06

(52) U.S. Cl. CPC G06N 3/08; G06Q 10/063112; G06N 3/0454

(57) ABSTRACT

A data set including at least skills data, recruiting data, compensation data, organization structure data can be received. A first training set can be created by cleaning and integrating the data set. A first machine learning model can be trained to predict skill scarcity associated with a skill, geography and organization using the first training set. A second training set can be created by selecting a subset of the first training set based on a local subject matter expert's input with respect to the trained first machine learning model's performance. The first machine learning model can be refined by retraining the first machine learning model using the second training set, the machine learning model refined to predict the skill scarcity associated with the skill, geography and organization within a locality associated with the local subject matter expert.

### BACKGROUND

The present application relates generally to computers and computer applications, and more particularly to machine learning algorithms and machine learning algorithms that predict skill scarcity.

While there are many statistical algorithms available, those algorithms can seem unrelated to the problem at hand for some decision makers. A technique is presented in this disclosure, which may develop a system and process to construct and identify an algorithm most appropriate for a problem in question at hand.

### BRIEF SUMMARY

A system and method for training and optimizing a machine learning model, which can predict skill scarcity can be provided. The system, in an aspect, may include a hardware processor. A memory device may be coupled with the hardware processor. The hardware processor may be configured to receive a data set including at least skills data, recruiting data, compensation data, organization structure data. The hardware processor also may be configured to create a first training set by cleaning and integrating the data set. The hardware processor also may be configured to train a first machine learning model to predict skill scarcity associated with a skill, geography and organization using the first training set. The hardware processor also may be configured to create a second training set by selecting a subset of the first training set based on a local subject matter expert's input with respect to the trained first machine learning model's performance. The hardware processor also may be configured to refine the first machine learning model by retraining the first machine learning model using the second training set, the machine learning model refined to predict the skill scarcity associated with the skill, geography and organization within a locality associated with the local subject matter expert.

A computer-implemented method of training and optimizing a machine learning model, which can predict skill scarcity, in one aspect, may include receiving a data set including at least skills data, recruiting data, compensation data, organization structure data, subject matter expert annotated data. The method may further include creating a first training set by cleaning and integrating the data set. The method may further include training a machine learning model to predict skill scarcity associated with a skill, geography and organization using the first training set. The method may further include creating a second training set by selecting a subset of the first training set based on a local subject matter expert's input with respect to the trained machine learning model's performance. The method may further include refining the machine learning model by retraining the machine learning model using the second training set, the machine learning model refined to predict the skill scarcity associated with the skill, geography and organization within a locality associated with the local subject matter expert.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating system architecture in one embodiment.

FIG. 2 is a diagram illustrating constructing and validating of machine learning models in an embodiment.

FIG. 3 shows visualization or graphics, which can be generated and presented for identifying skill scarcity algorithm in an embodiment.

FIG. 4 is a diagram showing an example waterfall chart comparing the number of features used with prediction accuracy in an embodiment.

FIG. 5 is a diagram illustrating a method in an embodiment.

FIG. 6 is a diagram showing components of a system in an embodiment that can identify and optimize skill scarcity algorithm or model.

FIG. 7 illustrates a schematic of an example computer or processing system that may implement a system according to an embodiment.

FIG. 8 illustrates a cloud computing environment in one embodiment.

FIG. 9 illustrates a set of functional abstraction layers provided by cloud computing environment in one embodiment of the present disclosure.

### DETAILED DESCRIPTION

A system, method and technique may be provided which can identify skill scarcity algorithms and optimize skill scarcity algorithm success. For example, the system in an embodiment can predict skill scarcity. In an embodiment, a machine learning technique can be used to train a machine learning model to predict skill scarcity. In an embodiment, the machine learning model may classify skill scarcity associated as “high”, “medium” and “low.” Delivery can be provided both in a visualization system format that is familiar and accessible to decision makers that facilitates the decision making process.

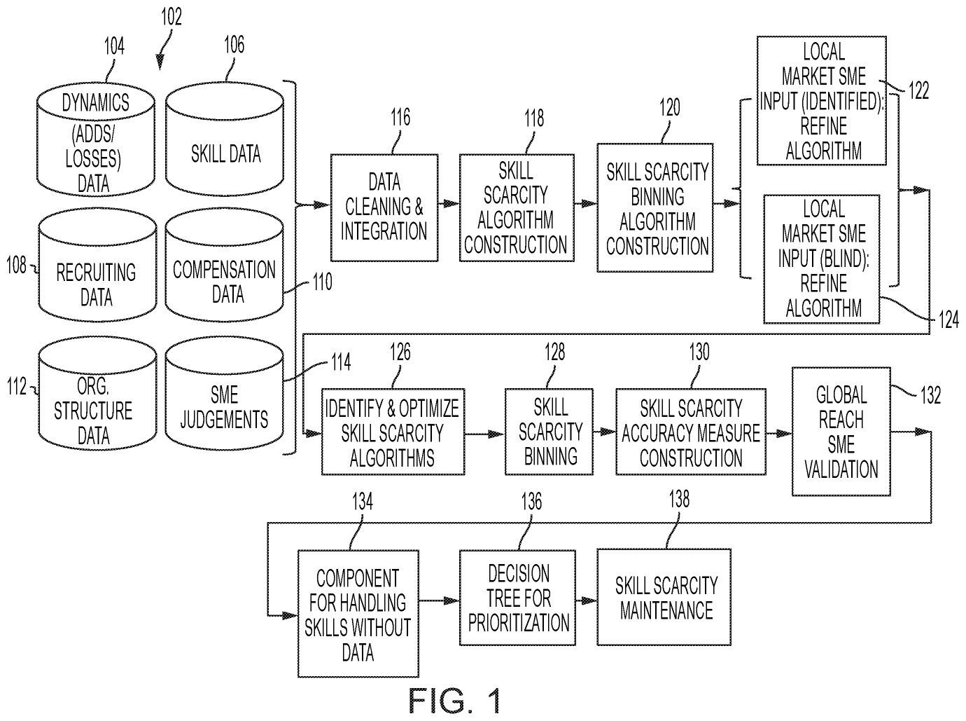

FIG. 1 is a diagram illustrating system architecture in one embodiment. The components shown include computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

Data set (e.g., input data) used in the system may include, but are not limited to data streams shown at 102. For example, data for training a machine learning model may include dynamics data 104 such as hiring data (adds) and voluntary attrition data (losses), for example, associated with one or more organizations or enterprises. Another type of data may include skills data 106, for example, job roles and role specialties and the mappings between them. Another type of data may include recruiting data 108 or recruiting information such as skills characteristics of job positions, job offer acceptance and approval data, and hiring manager information. Another type of data may include compensation data 110 such as current salaries and benchmark data in the industry or industries. Another type of data may include organization structure data 112, which may include data such as organization's departmental units, geographic units, and areas of service. Data sources can be used to extract features for a given record. Yet another type of data may include subject matter expert (SME) judgment data 114, which provide annotation data with respect to training machine learning models. For example, SME judgment data 114 includes labeled data used in supervised machine learning in training a model. SME judgment data 114 may include annotations or labels such as “high”, “medium”, “low” for the given record. A trained model can be executed or run to provide prediction or classification. SMEs may validate the trained model's output (e.g., prediction or classification). The data may be stored on one or more storage devices as structured or unstructured data and may be received, for example, retrieved from one or more storage devices and/or received via a remote computer over a computer network or data communications network, by one or more hardware processors implementing the system in an embodiment.

Data cleaning and integration component 116 may perform data cleaning and integrating such as removing duplicates, formatting into usable form or compatible form, combining similar data points, and the like to prepare the data 102 for use in training a machine learning model.

Skill scarcity algorithm construction component 118 constructs or builds a machine learning algorithm. An example of a machine learning algorithm may include, but not limited to, an artificial neural network or a neural network. As an example, a deep learning neural network can be constructed or built for training. Constructing a neural network, for example, neural network architecture can include determining input data or factors to be used for skill scarcity algorithm, and hyperparameters such as the number of levels in the neural network, the number of nodes in each of the levels, and output format. The skill scarcity algorithm construction component 118 builds a neural network, for example, based on such determination, and trains the neural network using the input training data.

Skill scarcity binning algorithm construction component 120 constructs or builds a model, for example, a machine learning model, that can perform binning or categorization of data, which may be output by a skill scarcity algorithm, for example, constructed by the skill scarcity algorithm construction component 118. As an example, a skill scarcity algorithm may output a range of values (e.g., 0 to 100). A binning algorithm constructed by the skill scarcity binning algorithm construction component 120 may classify or categorize the output values into a classification, category or bin. An example of a classification, category or bin can be “high”, “medium”, “low”. For instance, a skill scarcity binning algorithm may classify or categorize any one of output values (e.g., 0 to 100) into one of “high” “medium”, or “low” classification. Skill scarcity binning algorithm construction component 120 builds and trains a machine learning model.

An example of a machine learning model is a neural network model. An embodiment of an implementation of a neural network can include a succession of layers of neurons, which are interconnected so that output signals of neurons in one layer are weighted and transmitted to neurons in the next layer. A neuron Ni in a given layer may be connected to one or more neurons Nj in the next layer, and different weights wij can be associated with each neuron-neuron connection Ni-Nj for weighting signals transmitted from Ni to Nj. A neuron Nj generates output signals dependent on its accumulated inputs, and weighted signals can be propagated over successive layers of the network from an input to an output neuron layer. An artificial neural network machine learning model can undergo a training phase in which the sets of weights associated with respective neuron layers are determined. The network is exposed to a set of training data, in an iterative training scheme in which the weights are repeatedly updated as the network “learns” from the training data. An example training may include using a backpropagation technique to adjust or update the weights. The resulting trained model, with weights defined via the training operation, can be applied to perform a task based on new data. In an embodiment, a neural network can be implemented on special hardware such as a field programmable gate array (FPGA) or another processor implemented for neural network configuration. For instance, a special hardware may include memory cells or blocks that store the weights and a logic block or circuitry implementing the artificial neural network computations. Other supervised machined learning algorithms can be constructed.

Refine components 122 and 124 may refine the constructed models, for example, based on SMEs further input with respect to validating the output of the constructed models. Refining at 122 and 124 may include further focusing the constructed models to a specific target, for example, refining the constructed models for particular markets. A specific target can be geography-based, particular enterprise-based, and/or particular skill-based (job role-based). The local market SME input 122 may include SME input associated with a specific local market for specific skill area. The local market SME input 124 may include SME input associated with a specific local market for general skill area (e.g., markets in general).

Identify and optimize skill scarcity algorithms component 126 identifies a constructed algorithm or model, for example, a refined model optimized for a particular target. This component 126 may run the identified model. Input to the trained refined model can be a data tuple, for example, geographic location, enterprise or organization unit, and skill. The trained model can be run with the input data tuple, which can output indication of values, e.g., 0 to 100, which represents scarcity of the input skill in the input geographic location and organization unit. For instance, the trained model may output probability of the values, for each of values 0 to 100.

Skill scarcity binning component 128 runs a binning algorithm (e.g., constructed by the skill scarcity binning algorithm construction component 120). The binning algorithm classifies or categorizes the output values into classification such as “high”, “medium”, or “low”, representing whether the input skill in the input geographic location and organization unit is considered high, medium, or low. Other classification or categorization can be determined, for example, depending on the constructed binning algorithm.

Skill scarcity accuracy measure construction component 130 may construct or form a methodology for validation of the trained models' output, for example, output of the skill scarcity algorithm and/or binning algorithm. For example, a computer platform such as a cloud platform can be setup for allowing an SME to log in to the platform and view the output values, and provide validation input on the cloud platform, validating the accuracy of the output. In another aspect, spreadsheet data including the output can be transmitted to an SME to validate and send back to a system. SME validation component 132 can validate the trained models' outputs based on SME input, where the SMEs can be invited from the global market, for example, not limited to those from local markets.

A component at 134 may handle skills without data or enough data to be able to train a model. For example, a skill related to a newly developing technology may not have associated historical data. In such a case, the component 134 may set a default value, for example, which can be provided by an SME, for example, “medium” scarcity.

Decision tree for prioritization component 136 may take all constructed skill scarcity algorithms, their accuracy measurement, the coverage of skills by each algorithm, as well as the complexity and stability or volatility of each algorithm into account, and build a decision tree based on rules and input from decision makers. The output of this step is a decision tree, which includes a different set of skill scarcity algorithms at each tree leaf node. The decision tree may be used to assist decision makers to identify the optimal skill scarcity algorithm for a specific local market.

Skill scarcity maintenance component 138 may maintain the trained models, for example, updating (retraining) the models, e.g., periodically, based on additional acquired data. Retraining can be performed in a completely automatic or automated manner, in which a computer system may automatically detect a change or addition in training data set and automatically retrains a machine learning model. In another aspect, retraining can be performed in a completely automatic or automated manner every periodic interval of time.

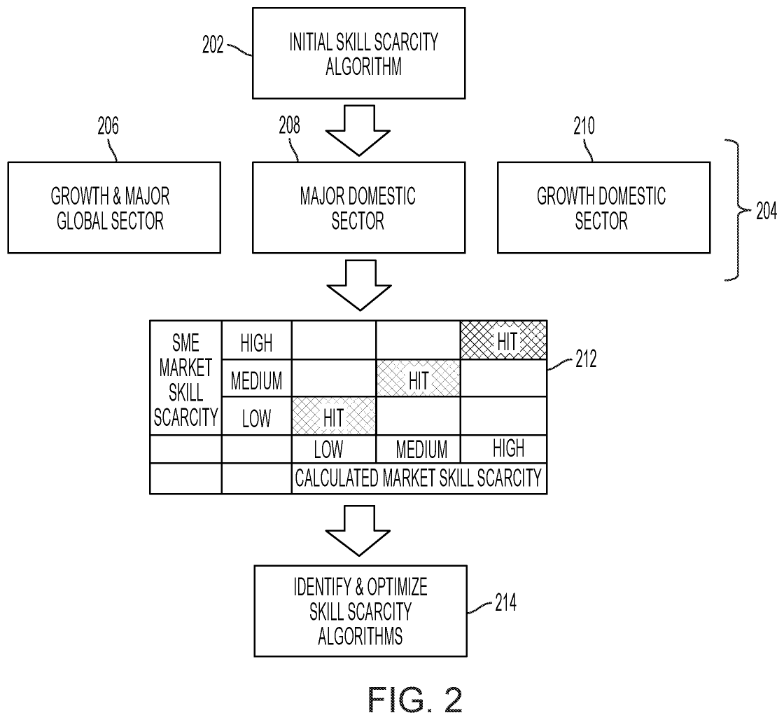

FIG. 2 is a diagram illustrating constructing and validating of machine learning models in an embodiment. One or more hardware processors may perform constructing and validating of machine learning models. For example, the components shown in FIG. 2 further explain the processes performed at 118, 122, 124 and 126 shown in FIG. 1. Referring to FIG. 2, at 202, an initial skill scarcity algorithm or model can be developed and run, for example, also as shown at 118, for different target areas. Examples of different target areas may include, but are not limited to, growth and major global market 206, major domestic market 208, and growth domestic market 210. One or more SME input for those target areas can be received, as shown at 204. SMEs with knowledge or understanding in those specific target areas can provide validation input with respect to the output generated by the initial skill scarcity algorithm at 202. For instance, validation of the initial skill scarcity algorithm can be performed based on an SME input.

The skill scarcity calculated using a specific model for a particular geography, enterprise unit and skill (referred to as “triplet” here) may be compared with SME input shown at 212. A processor may compare whether the algorithm's measurement matches with SME's input measurement. For example, as shown in 212, if the calculated market skill scarcity for a particular triplet is “Low”, and the SME's input for that triplet is also “Low”, then the processor may consider this as a hit or a match. Otherwise, the processor may consider it as a mismatch.

In an embodiment, shown at 214, optimized algorithms can be developed to focus on specific target areas. In this example, three more tailored algorithms or models can be developed, growth and major global market 206, major domestic market 208, and growth domestic market 210. For example, a subset of training data (factors or features) can be selected for each model, and trained based on those specific features. The subset features are those that influence the particular target area. The subset features can be selected based on determining how using different features affect the accuracy of the prediction, e.g., accuracy measure of model output. Those features that do not affect the accuracy measure to a degree (whether used or not used) can be dropped or not used. Those features that vary the accuracy measure by a degree (e.g., a predefined threshold) can be determined to be important.

Using one or more of the developed (trained) models, skill scarcity measure or data output from the developed model can be released into global production.

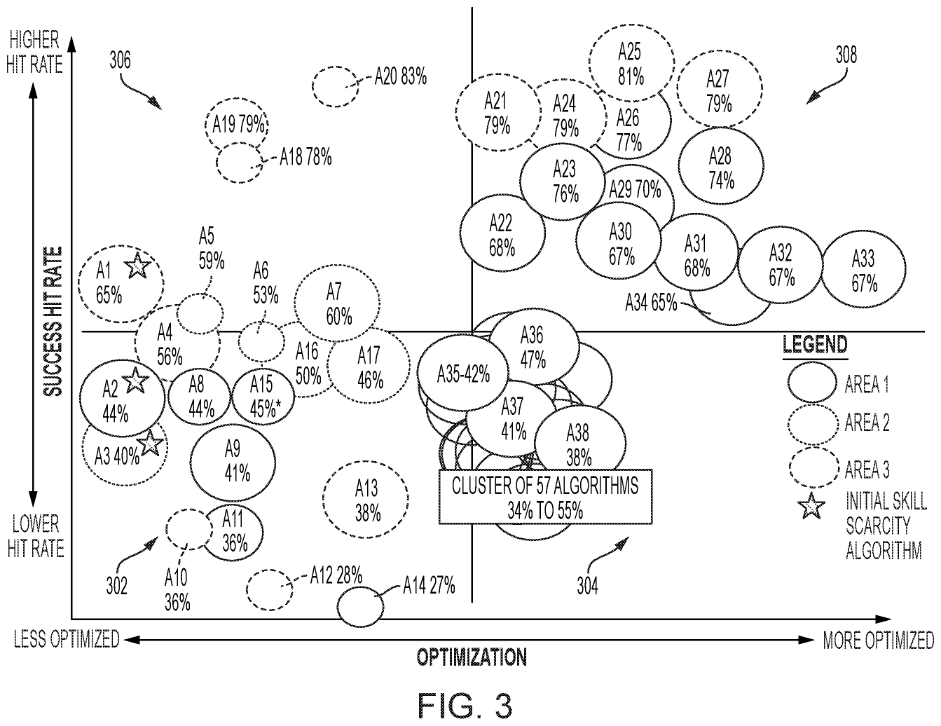

FIG. 3 shows visualization or graphics, which can be generated and presented for identifying skill scarcity algorithm in an embodiment. Visualization can be presented on a screen device of a computer or user device. In this example, the visualization includes representations of a plurality of machine learning algorithms developed, for example, for a plurality of areas (e.g., area 1, area 2, area 3). For instance, using the example shown in FIG. 2, area 1 may represent a growth and major global sector, area 2 can represent major domestic sector, and area 3 can represent growth domestic sector. Multiple machine learning algorithms can be developed and run. Different machine learning algorithms can have different architecture, different input features or factors used for training, and/or can be different types of models, e.g., deep learning neural network, a decision tree, a regression, etc. Each model can provide output with different level of accuracy (e.g., hit rate). In the example visualization each model is represented by a bubble floating or displayed on a 2-dimensional (x-y) plane. The x-axis represents the degree of optimization. The more a model is optimized, it may involve more complexity (e.g., more features considered) in building the model. The y-axis represents the degree of hit rate or accuracy. The plane can be divided into quadrants. The lower left quadrant 302 can include models which have lower hit rates, mixed skill coverage, lower volatility (bounce) and lower maintenance requirement (e.g., since the model may be less complex). Skill coverage can be measured based on the number of skills that the model is able to predict their scarcities. Volatility can be related to complexity. For example, if a model has a higher level of complexity, then that model tends to have a higher level of volatility, e.g., less stability. The lower right quadrant 304 can include models which have lower hit rate, mixed skill coverage, higher volatility (bounce) and higher maintenance requirement. The upper left quadrant 306 can have models which have higher hit rate, mixed skill coverage, lower to moderate volatility and moderate maintenance. The upper right quadrant 308 can have models with higher hit rate, higher skill coverage, higher volatility (bounce) and higher maintenance requirement. Initial skill scarcity algorithms can be shown with visual difference, for example, using an annotation (shown with “star” annotation in this example). A percentage value shown within a bubble indicates accuracy measure of the model represented by the bubble.

In an embodiment, such visualization can be presented or caused to be presented, for a user (e.g., a stakeholder) to select a model to use. In an embodiment, an automatic system may automatically select a model, for example, based on input configuration for selecting a model, for example, the importance or degree of factors such as hit rate, skill coverage, volatility and maintenance needs.

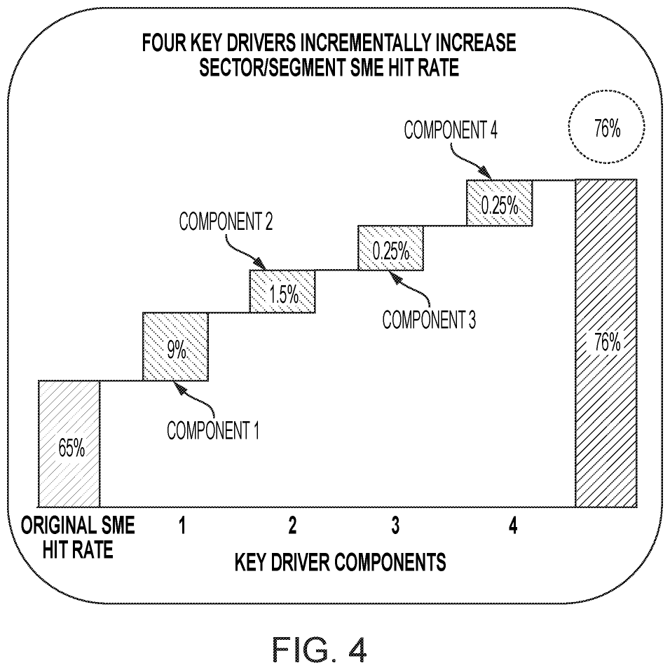

FIG. 4 is a diagram showing an example waterfall chart comparing the number of features used with prediction accuracy in an embodiment. In this example, four key driver components are considered in building or training a machine learning model. Using one of the four driver components (adding component 1) increases the accuracy of the machine learning model in its prediction or classification, for example, by 9%. Using two of the four driver components (adding component 2) increases the accuracy of the machine learning model in its prediction or classification, for example, by additional 1.5%. Using three of the four driver components (adding component 3) increases the accuracy of the machine learning model in its prediction or classification, for example, by additional 0.25%. Using all four driver components (adding component 4) increases the accuracy of the machine learning model in its prediction or classification, for example, by additional 0.25%. From the initial hit rate (or accuracy) of 65%, using additional four driver components results in a model with 76% accuracy measure. In an embodiment, an SME may determine or provide a label associated with a model's accuracy percentage or measure.

In an embodiment, a system and/or method may identify and optimize market skill scarcity algorithms and make them accessible and familiar to an organization's decision maker, for instance, to facilitate the decision maker's understanding and ability to evaluate various algorithms. In an embodiment, the system and/or method may identify a statistical market skill algorithm considered to be most appropriate for a particular enterprise or application and add results in an organization context for facilitating an organization's decision maker to understand modeling options. In an embodiment, the system and/or method may optimize the market skill scarcity algorithm success for providing a more user-friendly organization-relevant framework for evaluating algorithm success when the most appropriate statistical market skill scarcity algorithm is identified. In an embodiment, the system and/or method may deliver the identification and optimization of the market skill scarcity algorithms in a visualization system format that is familiar and accessible to a decision maker that facilitates the decision-making process.

In an embodiment, a system and/or method can derive the market scarcity of a given skill, which indicates the dynamic pull between an enterprise and the market for acquisition and retention of the skill. The system and/or method can provide an optimized approach to identifying an optimal algorithm that generates the scarcity index with relatively high accuracy. In a validation process, a local SME inputs can be used to optimize the algorithm.

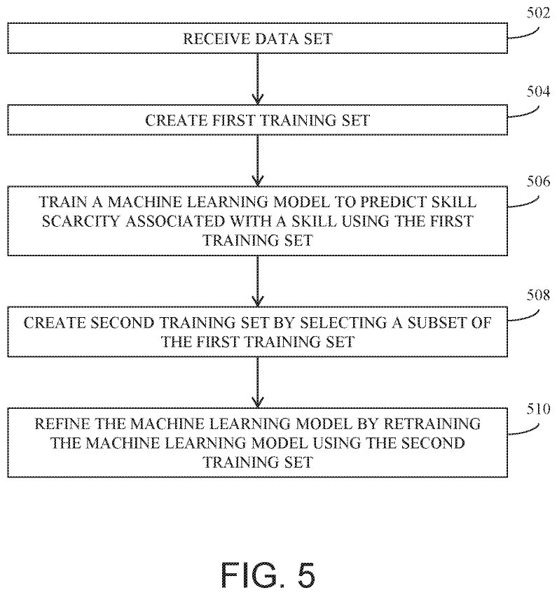

FIG. 5 is a diagram illustrating a method in an embodiment. The method can be a computer-implemented method of training and optimizing a machine learning model to predict skill scarcity. The method can be executed or performed by one or more hardware processors. For example, one or more hardware processors may be a central processing unit (CPU), a graphics processing unit (GPU), a field programmable gate array (FPGA), an application specific integrated circuit (ASIC), another suitable processing component or device, or one or more combinations thereof. One or more hardware processors may be coupled with a memory device. The memory device may include random access memory (RAM), read-only memory (ROM) or another memory device, and may store data and/or processor instructions for implementing various functionalities associated with the method described herein. The processor may execute computer instructions stored in the memory or received from another computer device or medium.

At 502, the method may include receiving a data set. The data set may include at least skills data, recruiting data, compensation data, organization structure data, subject matter expert annotated data. At 504, the method may include creating a first training set by cleaning and integrating the data set.

At 506, the method may include training a machine learning model to predict skill scarcity associated with a skill, geography and organization using the first training set. In an embodiment, the machine learning model can include a neural network model.

At 508, the method may include creating a second training set by selecting a subset of the first training set based on a local subject matter expert's input with respect to the trained machine learning model's performance. For instance, the output of the trained machine learning model can be provided to a subject matter expert in a specific locality (e.g., geographic region, an industry sector or market sector). The subject matter expert's evaluation or assessment of the accuracy of the output prediction can be used or taken into account to select a subset of the first training set.

At 510, the method may include refining the machine learning model by retraining the machine learning model using the second training set. In an embodiment, the machine learning model is refined to predict the skill scarcity associated with the skill within a locality associated with the local subject matter expert.

In an embodiment, a binning algorithm may classify or categorize output values into classification such as “high”, “medium”, or “low”, representing whether the input skill in the input geographic location and organization unit is considered high, medium, or low.

In an embodiment, the method may also include creating a plurality of second training sets by selecting a plurality of subsets of the first training set based on receiving a plurality of local subject matter experts' inputs respectively. The method may further include refining the first machine learning model into a plurality of first machine learning models based on the respective plurality of second training sets.

In an embodiment, the method may also include generating a graphic visualization for display on a display device. For example, the graphics visualization can include at least the refined plurality of first machine learning models positioned on an x-y plane based on a performance accuracy measure associated with each of the refined plurality of first machine learning models.

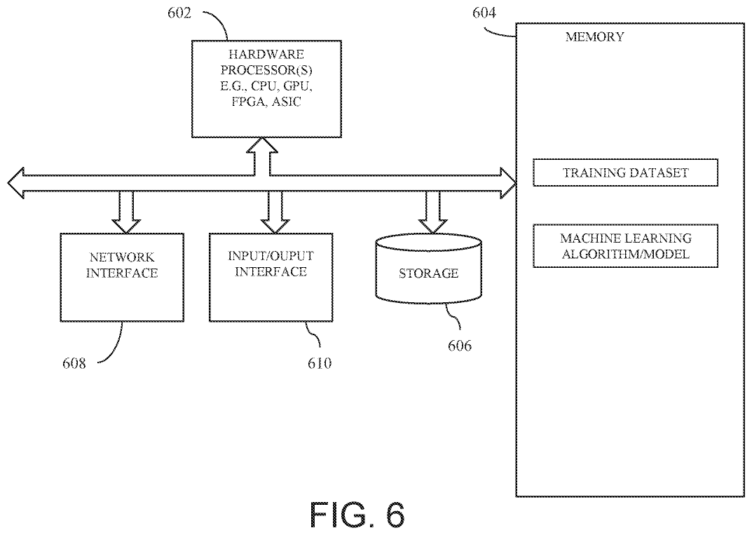

FIG. 6 is a diagram showing components of a system in an embodiment that can identify and optimize skill scarcity algorithm or model. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and construct and train a prediction model that can predict skill scarcity. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data. One or more hardware processors 602 may receive input comprising data sets. In an embodiment, the data sets can include skills data, recruiting data, compensation data, organization structure data, subject matter expert annotated data, based on which a machine learning model can be trained. In one aspect, one or more of the data sets may be stored on a storage device 606 and/or received via a network interface 608 from a remote device, and may be temporarily loaded into a memory device 604 for building or training a prediction model. The learned prediction model may be stored on a memory device 604, for example, for execution by one or more hardware processors 602. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

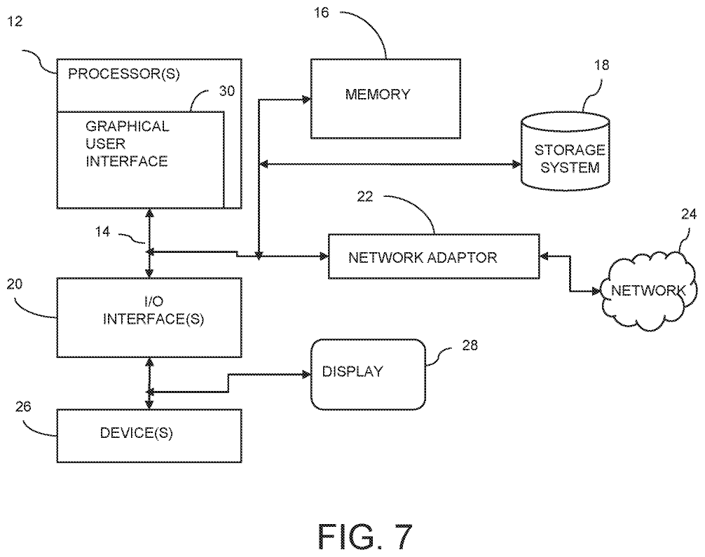

FIG. 7 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

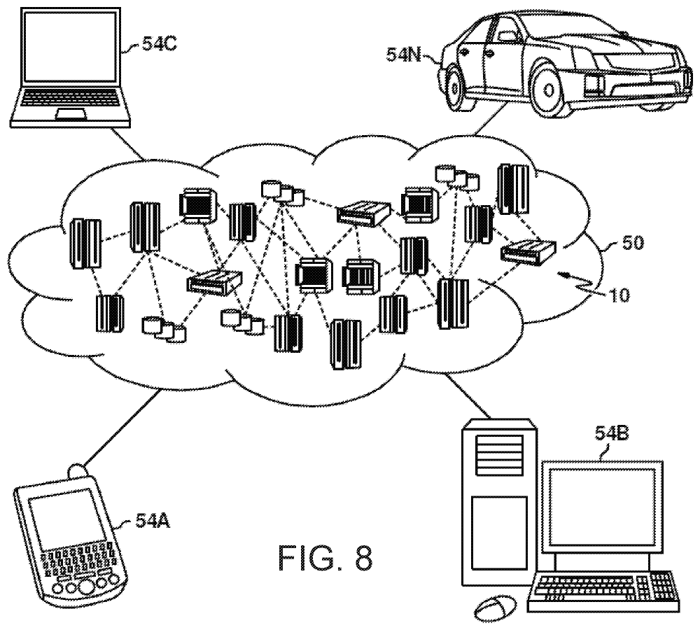

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

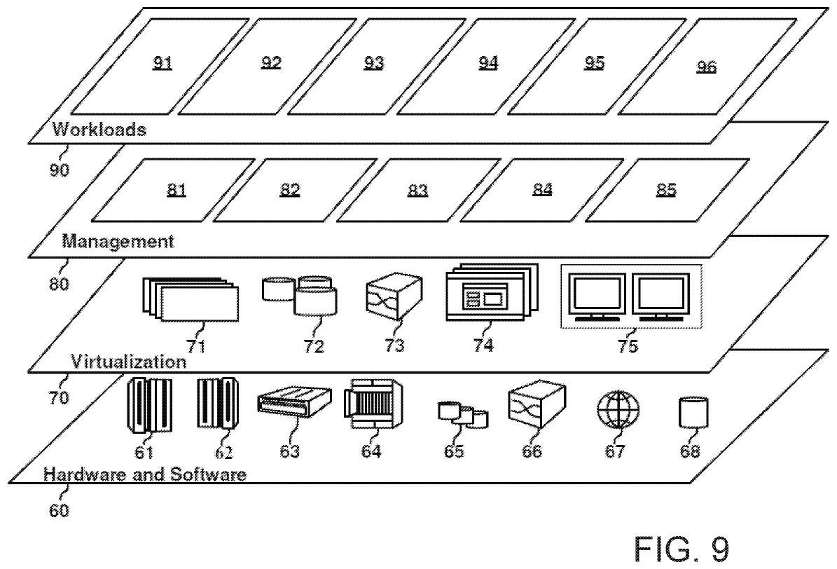

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and skill scarcity algorithm processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system for training and optimizing a machine learning model to predict skill scarcity, comprising:
a hardware processor;
a memory device coupled with the hardware processor;
the hardware processor configured to at least:
receive a data set including at least skills data, recruiting data, compensation data, organization structure data;
create a first training set by cleaning and integrating the data set;
train a first machine learning model to predict skill scarcity associated with a skill, geography and organization using the first training set;
create a second training set by selecting a subset of the first training set based on a local subject matter expert's input with respect to the trained first machine learning model's performance; and
refine the first machine learning model by retraining the first machine learning model using the second training set, the machine learning model refined to predict the skill scarcity associated with the skill, geography and organization within a locality associated with the local subject matter expert.

2. The system of claim 1, wherein the first machine learning model classifies predicted skill scarcity into labeled bins.

3. The system of claim 1, wherein the locality represents a specific industry sector.

4. The system of claim 1, wherein the locality represents a specific geographic region.

5. The system of claim 1, wherein the hardware processor is further configured to:
create a plurality of second training sets by selecting a plurality of subsets of the first training set based on receiving a plurality of local subject matter experts' inputs respectively; and
refine the first machine learning model into a plurality of first machine learning models based on the respective plurality of second training sets.

6. The system of claim 5, wherein the hardware processor is further configured to generate a graphic visualization for display on a display device, the graphics visualization including at least the refined plurality of first machine learning models positioned on an x-y plane based on a performance accuracy measure associated with each of the refined plurality of first machine learning models.

7. The system of claim 1, wherein the machine learning model includes a neural network model.

8. A computer program product comprising a computer readable storage medium having program instructions embodied therewith, the program instructions executable by a device to cause the device to:
receive a data set including at least skills data, recruiting data, compensation data, organization structure data;
create a first training set by cleaning and integrating the data set;
train a first machine learning model to predict skill scarcity associated with a skill, geography and organization using the first training set;
create a second training set by selecting a subset of the first training set based on a local subject matter expert's input with respect to the trained first machine learning model's performance; and
refine the first machine learning model by retraining the first machine learning model using the second training set, the machine learning model refined to predict the skill scarcity associated with the skill, geography and organization within a locality associated with the local subject matter expert.

9. The computer program product of claim 8, wherein the first machine learning model classifies predicted skill scarcity into labeled bins.

10. The computer program product of claim 8, wherein the locality represents a specific industry sector.

11. The computer program product of claim 8, wherein the locality represents a specific geographic region.

12. The computer program product of claim 8, wherein the device is further caused to:
create a plurality of second training sets by selecting a plurality of subsets of the first training set based on receiving a plurality of local subject matter experts' inputs respectively; and
refine the first machine learning model into a plurality of first machine learning models based on the respective plurality of second training sets.

13. The computer program product of claim 12, wherein the hardware processor is further configured to generate a graphic visualization for display on a display device, the graphics visualization including at least the refined plurality of first machine learning models positioned on an x-y plane based on a performance accuracy measure associated with each of the refined plurality of first machine learning models.

14. The computer program product of claim 8, wherein the machine learning model includes a neural network model.

15. A computer-implemented method of training and optimizing a machine learning model to predict skill scarcity, the method comprising:
receiving a data set including at least skills data, recruiting data, compensation data, organization structure data, subject matter expert annotated data;
creating a first training set by cleaning and integrating the data set;
training a machine learning model to predict skill scarcity associated with a skill, geography and organization using the first training set;
creating a second training set by selecting a subset of the first training set based on a local subject matter expert's input with respect to the trained machine learning model's performance; and
refining the machine learning model by retraining the machine learning model using the second training set, the machine learning model refined to predict the skill scarcity associated with the skill, geography and organization within a locality associated with the local subject matter expert.

16. The method of claim 15, wherein first machine learning model classifies predicted skill scarcity into labeled bins.

17. The method of claim 15, wherein the locality represents a specific industry sector.

18. The method of claim 15, wherein the locality represents a specific geographic region.

19. The method of claim 15, further comprising:
creating a plurality of second training sets by selecting a plurality of subsets of the first training set based on receiving a plurality of local subject matter experts' inputs respectively; and
refining the first machine learning model into a plurality of first machine learning models based on the respective plurality of second training sets.

20. The method of claim 19, further comprising:
generating a graphic visualization for display on a display device, the graphics visualization including at least the refined plurality of first machine learning models positioned on an x-y plane based on a performance accuracy measure associated with each of the refined plurality of first machine learning models.
